(19) United States
(12) Patent Application Publication
(10) Pub. No.: US 2026/0001979 A1
(43) Pub. Date: Jan. 1, 2026

(54) ULTRAVIOLET-CURABLE PROTECTIVE MATERIAL COMPOSITION AND MICRO LED DISPLAY USING THE SAME

(71) Applicant: O-Flex Co., Ltd., Daejeon (KR)

(72) Inventors: Se Ra KIM, Daejeon (KR); Hyun Jee YOO, Daejeon (KR); Moon Cheol SHIN, Daejeon (KR); Hyeon A KIM, Daejeon (KR)

(21) Appl. No.: 19/252,520

(22) Filed: Jun. 27, 2025

(30) Foreign Application Priority Data
Jun. 28, 2024 (KR) 10-2024-0085517

(51) Int. Cl. C08F 255/10; C08F 2/50; C08F 289/00; C09D 4/06

(52) U.S. Cl. CPC C08F 255/10; C08F 2/50; C08F 289/00; C09D 4/06

(57) ABSTRACT

The present disclosure relates to an ultraviolet-curable protective material composition comprising an oligomer having at least one backbone selected from hydrogenated polybutadiene and polyisobutylene, and having di-functional acrylate groups; an acrylate monomer, and a photoinitiator, wherein the composition has a Young's modulus of 100 MPa to 2,000 MPa at 25° C. and a tack force of less than 20 gf after UV curing.

### CROSS REFERENCE TO RELATED APPLICATION

The present application claims priority to Republic of Korea Patent Application No. 10-2024-0085517 filed on Jun. 28, 2024. The entire contents of the above-listed application are hereby incorporated by reference for all purposes.

### TECHNICAL FIELD

The present disclosure relates to an ultraviolet-curable protective material composition. More specifically, it relates to a composition suitable for use in forming a protective layer for micro-LED displays, and a micro-LED display employing the same.

### BACKGROUND ART

Micro-LED displays have emerged as an innovative technology in the display industry in recent years. Unlike traditional LCD or OLED technologies, micro-LED displays feature a unique structure that offers higher brightness and clearer image quality.

Micro-LED displays are characterized by the use of extremely small LEDs to form high-density and miniaturized LED arrays. By implementing a pixel pitch smaller than 10 micrometers, the pixel size is significantly reduced and each pixel emits light independently.

As such, a micro-LED display can increase resolution by placing more LEDs on the screen using small LEDs, and since individual LEDs form pixels, contrast can be adjusted at the pixel level to achieve high contrast, delivering excellent black levels even in dark scenes.

Furthermore, by combining small LEDs with a TFT (Thin Film Transistor) driving substrate, the brightness of each chip can be precisely controlled, allowing for delicate and realistic image representation.

Such display technology not only enhances the sharpness and color saturation of images, but also significantly reduces power consumption, achieving high efficiency and energy savings, thereby extending the lifespan of the LEDs and, over the long term, the overall lifespan of the display. Therefore, micro-LEDs generally have a longer lifespan compared to OLEDs and offer more than five times the power-saving effect.

Due to these technical advantages, micro-LEDs are expected to have diverse applications across various fields such as smartphones, smartwatches, head-up displays, large TVs, digital signage, onboard displays, and virtual reality devices

Micro-LED displays are high-precision devices that require stable operation. However, due to the miniaturization of LED sizes, the attachment area between the LEDs and the printed circuit board (PCB) and/or solder is reduced, making the LEDs more prone to detachment due to external impacts. Additionally, since LEDs are sensitive to heat and humidity, they may deteriorate over time and have a shortened lifespan if used without proper protection. Furthermore, when used in various environments—such as in outdoor billboards or portable devices that are exposed to external conditions—the durability and reliability of the display becomes particularly important.

Therefore, protective technologies for Micro-LEDs are essential for ensuring the performance, lifespan, and reliability of the display. Accordingly, various protective materials and techniques are currently being developed and studied.

### DISCLOSURE OF DISCLOSURE

### Technical Problem

The present disclosure aims to provide a micro-LED display that comprises a protective layer capable of protecting the LEDs and the circuit surface of the printed circuit board (PCB) within the micro-LED display from damage caused by heat, moisture, and physical impact, while simultaneously minimizing image quality degradation and preventing loss of visual fidelity.

Another objective of the disclosure is to provide a UV-curable protective material composition for forming the protective layer of the micro-LED display.

### Solution to Problem

The present disclosure provides an ultraviolet-curable protective material composition for forming a protective layer of a micro-LED display comprising:
an oligomer with at least one hydrogenated polybutadiene or polyisobutylene backbone and di-functional acrylate groups;
an acrylate monomer;
a photoinitiator;
wherein the composition has a Young's modulus of 100 MPa to 2,000 MPa at 25° C., and a tack force of less than 20 gf after UV curing.

In one embodiment, the ultraviolet-curable protective material composition may have a viscosity of 10 cps to 3,000 cps before UV curing.

In one embodiment, the ultraviolet-curable protective material composition may comprise: 10 to 50 parts by weight of the oligomer; 50 to 90 parts by weight of the acrylate monomer; and 0.05 to 5 parts by weight of the photoinitiator.

In one embodiment, the oligomer may have a weight average molecular weight of 3,000 to 100,000.

In one embodiment, the acrylate monomer may comprise functional groups capable of chemically bonding with a solder resist formed on the top surface of the PCB.

In one embodiment, the acrylate monomer may comprise at least one functional groups selected from epoxy, isocyanate, hydroxyl, silane, amide, and amine groups.

In one embodiment, the ultraviolet-curable protective material composition may further comprise one or more additives selected from pigments, dyes, antioxidants, thermal stabilizers, UV stabilizers, UV absorbers, flame retardants, and antistatic agents.

In one embodiment, the present disclosure also provides a micro-LED display comprising a protective layer formed by UV curing the UV-curable protective material composition.

### Advantageous Effects

The micro-LED display of the present disclosure prevents damage to LEDs from external impact through the protective layer laminated on the LED and PCB, while optimizing optical characteristics to maintain luminous performance. The protective layer features low moisture permeability, excellent weather resistance, and durability, while minimizing image quality loss.

Accordingly, the micro-LED display can maintain high image quality and provide stable performance over a long period.

### BRIEF DESCRIPTION OF DRAWINGS

FIG. 1 is a cross-sectional view of a micro-LED display according to one embodiment of the present disclosure.

FIG. 2 is a cross-sectional view of a micro-LED display according to another embodiment of the present disclosure.

FIG. 3 is a cross-sectional view of a micro-LED display according to yet another embodiment of the present disclosure.

FIG. 4 is a cross-sectional view of a micro-LED display according to yet another embodiment of the present disclosure.

### DETAILED DESCRIPTION OF THE DISCLOSURE

Hereinafter, exemplary embodiments of the present disclosure will be described in detail with reference to the accompanying drawings, such that those skilled in the art to which the disclosure pertains may easily carry out the disclosure. However, the disclosure can be implemented in various forms, and is not limited to the described embodiments. In the drawings, parts unrelated to the descriptions are omitted for clarity, and the same reference numerals are used for similar elements throughout the specification.

Throughout the present specification, when a part is described as being “connected,” “attached,” “adhered,” or “bonded” to another part, it comprises not only being “directly connected,” but also being “electrically connected” with another element interposed therebetween.

Throughout the present specification, when a component is described as being “on,” “above,” “over,” “under,” or “below” another component, it comprises both cases where the component is in contact with the other component and cases where another component is interposed between them.

Throughout the present specification, when a component is described as being “directly on,” “directly above,” “directly on top of,” “directly under,” “directly beneath,” or “directly below” another component, the component is in contact with the other component with no intervening component therebetween.

Throughout the present specification, when a part is described as “comprising” a certain component, it means that the part may comprise additional components as well, unless explicitly stated otherwise, and does not exclude the presence of other components.

All terms used in this specification, including technical and scientific terms, unless otherwise defined, are intended to have the same meaning as commonly understood by one of ordinary skill in the art to which this disclosure pertains. Additionally, the terms used herein should be interpreted as having meanings consistent with their usage in this specification and the relevant technical field, and should not be construed in an idealized or overly formal sense unless explicitly defined otherwise.

The present disclosure provides a UV-curable protective material composition and a micro-LED display to which it is applied.

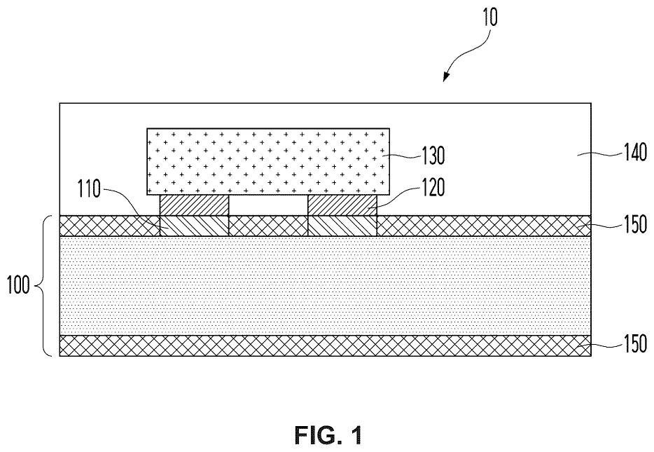

FIG. 1 is a cross-sectional view of a PCB including a protective layer formed from the UV-curable protective material composition.

One embodiment of the present disclosure provides a micro-LED display comprising: a PCB substrate (100); an electrode layer (110) located on at least a portion of the PCB substrate (100); solder (120) formed on at least a portion of the electrode layer (110); an LED (130) disposed on the solder (120) and connected to the electrode layer (110); a solder resist (150) positioned on the top surface of the PCB substrate (100), excluding the region of the electrode layer (110); and a protective layer (140) applied to the entire front surface of the PCB substrate (100), which has both the electrode layer (110) and the solder resist (150) laminated thereon.”

In one embodiment, the thickness (A) of the protective layer (140), measured from the topmost surface of the PCB substrate (100), may be equal to or greater than the combined thickness (B) of the solder and the thickness (C) of LED.

One or more additional layers may be stacked on the protective layer (140), or the protective layer may serve as the outermost surface of the micro-LED display.

The protective layer (140) is designed to enhance strength and adhesion with the surface of the PCB substrate (100), using materials resistant to external impacts and scratches to protect the LED (130) physically. At the same time, it optimizes optical characteristics to prevent deterioration of the LED (130) luminous characteristics. This design allows the micro-LED display device to maintain both high image quality and durability.

The protective layer (140) has low moisture permeability, excellent weather resistance, and durability, thereby protecting the LED. Additionally, it is designed to minimize image quality degradation of the LED display.

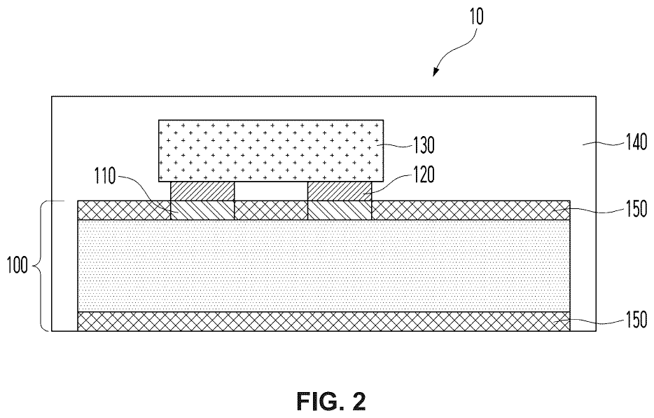

FIG. 2 is a cross-sectional view of another embodiment of the micro-LED display including the protective layer. As shown in FIG. 2, the protective layer (140) may be structured to cover the sides of the PCB substrate (100), thereby protecting the LED (130) from external impact and shielding the LED (130) and the circuit surface from external heat and moisture.

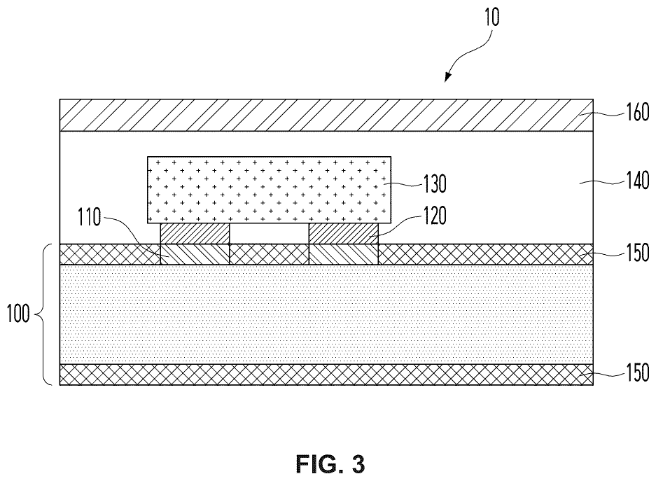

FIG. 3 is a cross-sectional view of another embodiment of the micro-LED display, including a light control film (160) disposed on top of the protective layer (140).

The light control film (160) is not limited and may be any film having a function of diffusing, refracting, reflecting, dispersing, or absorbing light, and can be optionally used to improve the visibility and color viewing angle of the micro-LED display.

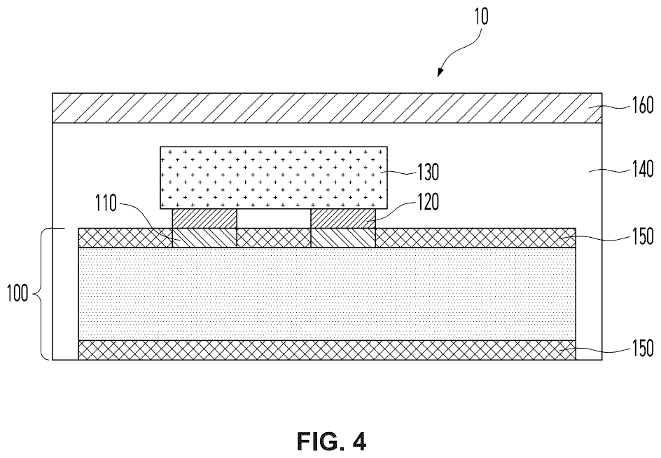

FIG. 4 illustrates a variation of FIG. 3, where the protective layer (140) is structured to also cover the sides of the PCB substrate (100), thereby providing further protection for the LED (130) from external impact and circuit surface from external heat and moisture.

The protective layer (140) may be formed by curing the ultraviolet-curable protective material composition of the present disclosure.

Hereinafter, the UV-curable protective material composition of the present disclosure will be described in more detail.

The ultraviolet-curable protective material composition comprises: an oligomer having at least one backbone selected from hydrogenated polybutadiene and polyisobutylene, and having di-functional acrylate groups; an acrylate monomer; and a photoinitiator, wherein the composition has a Young's modulus of 100 MPa to 2,000 MPa at 25° C. and a tack force of less than 20 gf after UV curing.

The UV-curable protective material composition of the present disclosure has a Young's modulus value in the range of 100 MPa to 2,000 MPa at 25° C., and optionally in the range of 150 MPa to 1,500 MPa. When this numerical range is satisfied, the UV-curable protective material composition can provide physical protection for the PCB itself and components laminated on the PCB, including the LEDs. In contrast, if the Young's modulus is less than 100 MPa at 25° C., the protective layer becomes vulnerable to physical damage, and if it exceeds 2,000 MPa, cracks may occur in the protective layer upon physical impact, making it difficult to sufficiently protect the LEDs under durability and reliability conditions.

The UV-curable protective material composition of the present disclosure has a tack force after UV curing of less than 20 gf. In one embodiment, the UV-curable protective material composition is applied to one side of the PCB and UV-cured to form a protective layer serving as the outermost surface of the micro-LED display. In this case, since the tack force after UV curing is below 20 gf, the surface of the protective layer remains below a certain tackiness threshold, preventing contamination of the exposed surface and thereby eliminating concerns about image quality degradation of the micro-LED display.

The UV-curable protective material composition has a viscosity before UV curing ranging from 10 cps to 3,000 cps, and optionally from 100 cps to 2,500 cps. Maintaining this viscosity range helps to eliminate the possibility of bubble formation around the LEDs during protective layer formation, thereby preventing deterioration in image quality and performance of the display. In contrast, if the viscosity of the UV-curable protective material composition exceeds 3,000 cps, bubbles may easily form around the LEDs when the UV-curable protective material composition is applied onto the PCB, and the removal of the generated bubbles is difficult. Consequently, this leads to degradation of the optical characteristics of the display device and may cause appearance defects after durability testing.

In one embodiment, the UV-curable protective material composition comprises an oligomer having at least one backbone selected from hydrogenated polybutadiene and polyisobutylene, and having di-functional acrylate groups; an acrylic monomer; and a photoinitiator.

In one embodiment, the ultraviolet-curable protective material composition comprises: 10-50 parts by weight of the oligomer; 50-90 parts by weight of the acrylate monomer; and 0.05-5 parts by weight of the photoinitiator.

Hereinafter, each component comprised in the UV-curable protective material composition of the present disclosure will be described in detail.

The UV-curable protective material composition of the present disclosure comprises an oligomer having at least one backbone selected from hydrogenated polybutadiene and polyisobutylene, and having di-functional acrylate groups. By comprising such an oligomer, the composition provides a protective layer with excellent durability and protection performance for the LEDs in the display by significantly reducing moisture and gas permeability. The oligomer having at least one backbone selected from hydrogenated polybutadiene and polyisobutylene has a weight-average molecular weight of 3,000 to 100,000, optionally 5,000 to 95,000. If the weight-average molecular weight is less than 3,000, the protective layer has poor durability due to high crosslink density and brittleness. If the weight-average molecular weight exceeds 100,000, UV curing becomes insufficient, leading to durability issues due to residual unreacted materials.

The oligomer having at least one backbone selected from hydrogenated polybutadiene and polyisobutylene in the present disclosure includes di-functional acrylate groups. If the oligomer has only one acryl functional group, the UV curing rate is slow, and there may be durability reliability issues due to unreacted materials. Conversely, if the oligomer has three or more acryl functional groups, the crosslink density becomes too high, potentially causing cracks in the protective layer and delamination between the protective layer, and the adjacent LED and solder resist layers, significantly degrading durability and reliability.

The content of the oligomer in the UV-curable protective material composition is 10 to 50 parts by weight. If the content is less than 10 parts by weight, there is a risk of LED damage and corrosion of the exposed circuit surface on the PCB due to reduced moisture barrier properties. If the content exceeds 50 parts by weight, the viscosity becomes too high, increasing bubble formation and making their removal difficult.

The acrylic monomer of the present disclosure used may comprise one or more of the following: methyl(meth)acrylate, ethyl(meth)acrylate, n-propyl(meth)acrylate, isopropyl(meth)acrylate, n-butyl(meth)acrylate, t-butyl(meth)acrylate, sec-butyl(meth)acrylate, pentyl(meth)acrylate, 2-ethylhexyl(meth)acrylate, n-hexyl acrylate, n-octyl(meth)acrylate, isooctyl(meth)acrylate, isononyl(meth)acrylate, isobonyl(meth)acrylate, glycidyl(meth)acrylate, hydroxyethyl(meth)acrylate, lauryl(meth)acrylate, tetradecyl(meth)acrylate, benzyl(meth)acrylate, cyclohexyl(meth)acrylate, tetrahydrofurfuryl(meth)acrylate, morpholinyl(meth)acrylate, and (meth)acrylate or acrylic acid having an alkoxy group. Optionally, the acrylic monomer comprises functional groups capable of chemically bonding with a solder resist formed on the surface of the PCB, such as at least one selected from epoxy, isocyanate, hydroxy, silane, amide, and amine groups.

In one embodiment, examples of the acrylic monomer comprise epoxy (meth)acrylate, 2-hydroxyethyl(meth)acrylate, 3-hydroxypropyl(meth)acrylate, 4-hydroxybutyl(meth)acrylate, 3-(meth)acryloyloxypropyl triethoxysilane, 3-(meth)acryloyloxypropyl trimethoxysilane, N,N-dimethyl acrylamide, N,N-diethyl acrylamide, and (meth)acryloyloxyethyl isocyanate, with epoxy (meth)acrylate being preferred. In this case, the adhesion between the protective layer and the solder resist on the PCB surface is improved, thereby enhancing durability and reliability and preventing bubble formation and delamination.

The content of the acrylic monomer in the UV-curable protective material composition is 50 to 90 parts by weight. If the content is less than 50 parts by weight, the high viscosity may cause bubble formation during the formation of the protective layer and make bubble removal difficult. If the content exceeds 90 parts by weight, the toughness of the protective layer becomes insufficient, making it prone to cracking upon physical impact.

As the photoinitiator of the present disclosure, any UV-activated material that generates radicals upon exposure to UV light to initiate polymerization may be used. The type of photoinitiator used in the present disclosure is not particularly limited, and various photoinitiators such as ketones of benzophenone and acetophenone types, peroxides, phosphine oxides, benzoin, benzoin ethers, benzyl, and benzyl ketals may be selected and used. Specific examples include one or more selected from 1-hydroxycyclohexyl phenyl ketone, 1-hydroxy-2-methyl-1-phenylpropane-1-ketone, 2-chlorothioxanthone, 2-isopropylthioxanthone, 2,2-dimethoxy-2-phenylacetophenone, 2,4,6-trimethylbenzoyl-diphenyl phosphine oxide, ethyl (2,4,6-trimethylbenzoyl)-phenylphosphinate, bis(2,4,6-trimethylbenzoyl)-phenylphosphine oxide, and benzophenone.

The content of the photoinitiator in the UV-curable protective material composition is 0.05 to 5 parts by weight. If the content is less than 0.05 parts by weight, UV curing may not proceed sufficiently. If the content exceeds 5 parts by weight, unreacted photoinitiator may remain in the cured product, potentially causing yellowing issues.

The UV-curable protective material composition of the present disclosure may further comprise one or more additives such as pigments, dyes, antioxidants, heat stabilizers, UV stabilizers, UV absorbers, flame retardants, or antistatic agents, without limitation to known materials.

In one embodiment of the present disclosure provides a micro-LED display comprising a protective layer formed by UV-curing the above-described UV-curable protective material composition.

The following embodiments further illustrate the configuration and operation of the present disclosure. However, these embodiments are provided for illustrative purposes only and do not limit the scope of the disclosure.

### Examples: Preparation of Ultraviolet-Curable Composition

### Example 1

41 parts by weight of a difunctional acrylate oligomer having a polyisobutylene structure and a weight-average molecular weight of 15,000; 50 parts by weight of isobornyl acrylate; 3 parts by weight of isooctyl acrylate and 6 parts by weight of glycidyl methacrylate were mixed. Then, 1.0 part by weight of a photoinitiator, 2,2-dimethoxy-2-phenylacetophenone (IRGACURE 651, manufactured by Ciba Specialty Chemicals), was added. The mixture was stirred and defoamed to prepare a UV-curable protective material composition.

### Example 2

14 parts by weight of a difunctional acrylate oligomer including a hydrogenated polybutadiene structure and a weight-average molecular weight of 47,000; 29 parts by weight of lauryl methacrylate; 39 parts by weight of isobornyl acrylate; 3 parts by weight of hydroxybutyl acrylate; and 15 parts by weight of glycidyl methacrylate were mixed. Then, 0.8 part by weight of a photoinitiator, 2,2-dimethoxy-2-phenylacetophenone (IRGACURE 651, manufactured by Ciba Specialty Chemicals) was added. The mixture was stirred and defoamed to prepare a UV-curable protective material composition.

### Comparative Example 1

28 parts by weight of a urethane acrylate oligomer made of polyol and diisocyanate and having a weight-average molecular weight of 35,000; 46 parts by weight of isobornyl acrylate; 20 parts by weight of cyclohexyl acrylate; and 6 parts by weight of glycidyl methacrylate were mixed. Then, 1.0 part by weight of a photoinitiator, 2,2-dimethoxy-2-phenylacetophenone (IRGACURE 651, manufactured by Ciba Specialty Chemicals) was added. The mixture was stirred and defoamed to prepare a UV-curable protective material composition.

### Comparative Example 2

64 parts by weight of a difunctional acrylate oligomer having a polyisobutylene structure and a weight-average molecular weight of 54,000; 11 parts by weight of isobornyl acrylate; and 25 parts by weight of lauryl methacrylate were mixed. Then, 1.0 part by weight of a photoinitiator, 2,2-dimethoxy-2-phenylacetophenone (IRGACURE 651, manufactured by Ciba Specialty Chemicals) was added. The mixture was stirred and defoamed to prepare a UV-curable protective material composition.

### Comparative Example 3

35 parts by weight of a tetrafunctional acrylate oligomer including a hydrogenated polybutadiene structure and a weight-average molecular weight of 19,000; 24 parts by weight of lauryl methacrylate; 35 parts by weight of isobornyl acrylate; and 6 parts by weight of glycidyl methacrylate were mixed. Then, 1.0 part by weight of a photoinitiator, 2,2-dimethoxy-2-phenylacetophenone (IRGACURE 651, manufactured by Ciba Specialty Chemicals) was added. The mixture was stirred and defoamed to prepare a UV-curable protective material composition.

### Comparative Example 4

24 parts by weight of a difunctional acrylate oligomer including a hydrogenated polybutadiene structure and a weight-average molecular weight of 47,000; 39 parts by weight of lauryl methacrylate; 19 parts by weight of isobornyl acrylate; 3 parts by weight of hydroxybutyl acrylate; and 15 parts by weight of glycidyl methacrylate were mixed. Then, 0.8 part by weight of a photoinitiator, 2,2-dimethoxy-2-phenylacetophenone (IRGACURE 651, manufactured by Ciba Specialty Chemicals) was added. The mixture was stirred and defoamed to prepare a UV-curable protective material composition.

### Experimental Examples—Property Evaluation

### (1) Viscosity

The compositions prepared in the above Examples and Comparative Examples were measured for viscosity at room temperature using a Brookfield viscometer (No. 64 spindle). RPM was adjusted to achieve a torque of 20-40%.

### (2) Young's Modulus

The compositions prepared in the Examples and Comparative Examples were applied onto a polyester release film using a bar coater to form a protective layer with a thickness of 500 μm. To prevent contact with oxygen, another polyester release film was laminated over the formed protective layer. Then, UV curing was performed from one side using a 365 nm LED UV lamp until a total exposure of 3000 mJ/cm² was achieved, and both release films were removed to obtain a standalone sample of the UV-cured protective layer.

The resulting UV-cured protective layer was cut into test specimens with dimensions of 10 mm in width and 100 mm in length. Each specimen was mounted between two grips of a UTM (Universal Testing Machine) with a 50 mm gauge length and pulled at a rate of 100 mm/min until fracture. A stress-strain curve was recorded, and the Young's modulus was calculated from the slope between 0.1% and 1% strain.

### (3) Tack Force

The compositions prepared in the above Examples and Comparative Examples were applied across the surface of a PCB panel on which 250 μm-high LEDs were mounted, forming a 500 μm-thick layer. A polyester release film was laminated on top of the applied protective layer to prevent contact with oxygen. UV curing was performed from the release film side using a 365 nm LED UV lamp until a total exposure of 3000 mJ/cm² was achieved. After curing, the polyester release film was removed to complete the micro-LED panel.

Tack force was measured on the outermost surface of the protective layer using a Texture Analyzer. A 1-inch SUS ball was pressed down at 0.1 mm/s with a force of 800 gf and held for 1 second. Then, it was retracted at 1 mm/s, and the maximum force during retraction was recorded as the tack force.

### (4) Adhesion

The compositions prepared in the above Examples and Comparative Examples were applied across the surface of a PCB panel on which 250 μm-high LEDs were mounted, forming a 500 μm-thick layer. A polyester release film was laminated on top of the applied protective layer to prevent contact with oxygen. UV curing was performed from the release film side using a 365 nm LED UV lamp until a total exposure of 3000 mJ/cm² was achieved. After curing, the polyester release film was removed to complete the micro-LED panel.

Adhesion was evaluated by using a blade to separate the interface between the PCB and the protective layer from the side, based on the following criteria:
O: No lifting or delamination observed between the PCB and the protective material
X: Lifting or delamination observed between the PCB and the protective material

### (5) Appearance Observation

The compositions prepared in the above Examples and Comparative Examples were applied across the surface of a PCB panel on which 250 μm-high LEDs were mounted, forming a 500 μm-thick layer. A polyester release film was laminated on top of the applied protective layer to prevent contact with oxygen. UV curing was performed from the release film side using a 365 nm LED UV lamp until a total exposure of 3000 mJ/cm² was achieved. After curing, the polyester release film was removed to complete the micro-LED panel.

Prepared completed micro-LED panels were observed under a microscope to check for bubble formation around the LEDs:
O: No bubbles observed around the LEDs
X: Bubbles observed around the LEDs

### (6) Durability and Reliability

The compositions prepared in the above Examples and Comparative Examples were applied across the surface of a PCB panel on which 250 μm-high LEDs were mounted, forming a 500 μm-thick layer. A polyester release film was laminated on top of the applied protective layer to prevent contact with oxygen. UV curing was performed from the release film side using a 365 nm LED UV lamp until a total exposure of 3000 mJ/cm² was achieved. After curing, the polyester release film was removed to complete the micro-LED panel.

Prepared micro-LED panels were stored under high temperature and humidity conditions (85° C., high humidity) for 300 hours. Post-aging, the appearance and functionality of the LEDs were evaluated:
O: No visible changes such as bubbles or delamination; full light emission observed during operation without LED damage.
X: Visible changes such as bubbles or delamination occurred; non-light emitting areas observed during operation due to LED damage.

TABLE 1

| | Example | Example | Comp. Ex. | Comp. Ex. | Comp. Ex. | Comp. Ex. |
|---|---|---|---|---|---|---|
| Category | 1 | 2 | 1 | 2 | 3 | 4 |
| Viscosity (cps) | 1150 | 175 | 358 | 3750 | 657 | 755 |
| Young's Modulus | 998 | 135 | 486 | 20 | 965 | 57 |
| (MPa) | | | | | | |
| Tack Force (gf) | 2 | 15 | 9 | 50 | 2 | 35 |
| Adhesion | ◯ | ◯ | ◯ | X | ◯ | ◯ |
| Appearance | ◯ | ◯ | ◯ | X | ◯ | ◯ |
| Durability and | ◯ | ◯ | X | X | X | X |
| reliability | | | | | | |

As shown in Table 1, Examples 1 and 2 both exhibited excellent adhesion between the PCB and the protective layer. Due to their appropriate viscosity, bubble formation was suppressed, and no lifting or delamination occurred. Furthermore, the UV-curable protective material compositions of the present disclosure showed a Young's modulus in the range of 100 MPa to 2000 MPa and a tack force of less than 20 gf after curing, confirming their suitability as the outermost protective layer.

In contrast, Comparative Examples 1 to 4 all exhibited bubble formation at the interface between the PCB and the protective layer, resulting in visible lifting phenomena. Additionally, delamination of the protective layer from the LEDs and solder resist was observed, indicating reduced durability and reliability.

Specifically, Comparative Example 1 did not include an oligomer having a hydrogenated polybutadiene or polyisobutylene structure, which led to a decrease in durability under high-temperature and high-humidity conditions. Comparative Example 4, despite using a difunctional acrylate oligomer with a hydrogenated polybutadiene structure, showed insufficient durability due to low Young's modulus (hardness) and was unsuitable as the outermost layer due to its high tack force.

In particular, Comparative Example 2, which contained a different formulation than that of the present disclosure and had high viscosity, resulted in bubble formation around the LEDs. Consequently, not only the optical performance but also the durability and appearance of the display failed to meet the required standards. Moreover, the low Young's modulus decreased the adhesion reliability between the PCB and the protective layer as well as the reliability of the protective layer. The combination of low modulus and high tack force made it unsuitable for use as the outermost display layer.

### Drawing Reference Numerals

10: LED display module
100: PCB substrate
110: Electrode layer
120: Solder
130: LED
140: Protective layer
150: Solder resist
160: Light control film
A: Thickness of the protective layer
B: Thickness of solder
C: Thickness of LED

1. An ultraviolet-curable protective material composition comprising: an oligomer having at least one backbone selected from hydrogenated polybutadiene and polyisobutylene, and having di-functional acrylate groups; an acrylate monomer; and a photoinitiator, wherein the composition has a Young's modulus of 100 MPa to 2,000 MPa at 25° C. and a tack force of less than 20 gf after UV curing.

2. The ultraviolet-curable protective material composition of claim 1, wherein the viscosity is 10 cps to 3,000 cps before UV curing.

3. The ultraviolet-curable protective material composition of claim 1, comprising: 10-50 parts by weight of the oligomer; 50-90 parts by weight of the acrylate monomer; and 0.05-5 parts by weight of the photoinitiator.

4. The ultraviolet-curable protective material composition of claim 1, wherein the oligomer has a weight-average molecular weight of 3,000 to 100,000.

5. The ultraviolet-curable protective material composition of claim 1, wherein the acrylate monomer comprises functional groups capable of chemically bonding with a solder resist formed on a topmost layer of a PCB.

6. The ultraviolet-curable protective material composition of claim 5, wherein the acrylate monomer comprises at least one functional groups selected from epoxy, isocyanate, hydroxyl, silane, amide, and amine.

7. The ultraviolet-curable protective material composition of claim 1, further comprising one or more additives selected from pigments, dyes, antioxidants, thermal stabilizers, UV stabilizers, UV absorbers, flame retardants, and antistatic agents.

8. A micro-LED display comprising a protective layer formed by UV curing the ultraviolet-curable protective material composition according to claim 1.
